(19) United States
(12) Patent Application Publication
(10) Pub. No.: US 2003/0018499 A1
(43) Pub. Date: Jan. 23, 2003

(54) System and methods for continuous fare shopping and virtual grouping of itinerary requests

(76) Inventors: Rodney D. Miller, Flower Mound, TX (US); Lezlie M. Terry, Ft. Worth, TX (US); Victor A. Nilson, Southlake, TX (US)

Correspondence Address: FINNEGAN, HENDERSON, FARABOW, GARRETT &, DUNNER LLP, 1300 I STREET, NW, WASHINGTON, DC, 20006, US

(21) Appl. No.: 09/779,973

(22) Filed: Feb. 9, 2001

(51) Int. Cl. G06F 17/60

(52) U.S. Cl. 705/5

(57) ABSTRACT

A system and methods for auctioning consumer demand to suppliers comprising: a request adapter for receiving a first data set in a first protocol, converting the first data set to a second data set in a second intermediate protocol and then, converting the second data set to a third data set in a third protocol; a request preprocessor for receiving the third data set from the request adapter and filtering the third data set; a virtual group processor for receiving the third data set, which has been filtered by the request preprocessor and not rejected, and creating at least one group, including the third data set and other data sets in the third protocol; and a dynamic packaging orchestrator and continuous shopping engine for managing the at least one group, shopping for bids on at least one product represented in the at least one group, and booking the at least one product based on the received bids.

### BACKGROUND OF THE INVENTION

A. Field of the Invention

The invention relates to the purchasing of travel-related services and products, and more particularly, to systems and methods for offering bids to suppliers of grouped consumer requests for travel-related products and services, and using event and availability information to purchase travel-related products and services.

B. Description of the Related Art

Traditionally, consumers of travel services or products made reservations either through a travel agent or directly with the service or product provider of their choice. When a consumer uses a travel agent to purchase the travel service or product, the travel agent books the requested travel service or product through a computerized reservation system (CRS). During the booking process, the CRS provides the travel agent with the cost for the product or service, based on the individual request submitted, and creates a computer record called the Passenger Name Record (PNR). As the travel agent books flights with different carriers, the CRS sends a message with the flight information to the airline's computers to generate tickets and itineraries.

Currently, consumers can access information on the World Wide Web (“the web”) using a computer program called a web browser, such as the Netscape Navigator from Netscape Communications Corporation. With a web browser consumers are able to connect, through the web, to computer systems operated by suppliers of various travel products and services. These suppliers download information from the various CRSs and allow consumers, on an individual basis, to query this information for the desired product or service.

The systems and methods in the present invention overcome the limitations of the traditional and current systems and methods.

### SUMMARY OF THE INVENTION

Accordingly, systems and methods consistent with the present invention obviate one or more of the problems of existing systems and methods for consumers to book the lowest possible price for travel-related products and services.

In accordance with one aspect of the present invention, as embodied and broadly described herein, a method is used for auctioning consumer demand to suppliers in a travel information network comprising: transferring a Personal Name Record (PNR) from a distribution system to a request adapter for conversion to a travel request; transferring the travel request from the request adapter to a request preprocessor, which filters the travel request (i.e., accepts or rejects the travel request, based on a set of elimination rules); transferring the filtered travel requests to a virtual group processor, which forms at least one group of travel requests, including the filtered travel request and other travel requests; and transferring the at least one group of travel requests from the virtual group processor to a dynamic packaging orchestrator and continuous shopping engine module.

The dynamic packaging orchestrator and continuous shopping engine module (DPO/CSE module) manages the at least one group of travel requests by disassembling the one or more products represented in the group and reorganizing the one or more products into one or more combinations before offering them for bid to prospective suppliers, locates bids for the one or more combinations, receives the bids for the one or more combination of products from prospective suppliers, and books the one or more combination of products with a global distribution system (GDS).

In accordance with another aspect of the invention, a dynamic flight connection constructor module is provided for receiving the flight request from the DPO/CSE module. Based on the departure and arrival information in the flight request and flexibility parameters, the dynamic flight connection constructor module generates a list of alternative flight requests. The alternative travel requests may include multiple connections between the departure and arrival locations in the original flight request. The alternative travel requests are submitted to the suppliers for bidding, and if an appropriate offer is made, the bid is accepted and the flight request is booked.

In accordance with yet another aspect of the invention, a bid management module comprising a trading engine, supplier product queues, supplier proxy agents, and a proxy rules module is provided for bid management. When the bid management module receives the separate requests from the dynamic packaging management module, the trading engine transmits the requests for bids to the supplier product queues.

The supplier proxy agents then retrieve the requests for bids from the supplier queues and automatically bid on the requests, using proxy rules supplied by the proxy rules module. Suppliers also may monitor the supplier product queues and bid on products or services manually. The automatic bids and the manual bids are then transmitted to the trading engine.

In addition to receiving automatic bids and manual bids, the trading engine receives information from the fare and availability monitor and time triggers, which continually transmit information such as fare changes and reservation cancellations from the GDS. Using the fare and availability monitor and time triggers, the DPO/CSE module continuously shops for travel products (e.g., flight, hotel, or car offerings) to satisfy the travel request, and books the request if an appropriate price is received.

### BRIEF DESCRIPTION OF THE DRAWINGS

The accompanying drawings, which are incorporated in and constitute a part of this specification, illustrate an implementation of the invention and, together with the description, serve to explain the advantages and principles of the invention. In the drawings,

FIG. 1 is a block diagram of an exemplary embodiment of a system in accordance with the present invention;

FIG. 2 is a block diagram of an exemplary embodiment of the travel request adaptor in accordance with the present invention;

FIG. 3 is a block diagram of an exemplary embodiment of the dynamic packaging orchestrator and continuous shopping engine module (DPO/CSE module) in accordance with the present invention; and

FIG. 4 is a block diagram of an exemplary embodiment of the bid management module of the present invention.

### DETAILED DESCRIPTION

Reference will now be made in detail to an embodiment of the invention, an example of which is illustrated in the accompanying drawings. Wherever possible, the same reference numbers will be used throughout the drawings to refer to the same or like parts.

Overview

Systems and methods consistent with the present invention provide a facility for users to request items, including for example, products or services, and for potential suppliers of these items to submit bids in response to the requests. Such systems and methods receive requests for items from at least one of a plurality of sources. Certain requests are received in a format or protocol for immediate processing but others may not, in which case they are formatted for processing using a predetermined protocol. Any requests that fail to meet predetermined criteria are then eliminated. The criteria may be different for each type of item specified in a request. For example, a request may indicate an interest in buying two items. The requester, however, specifies a price for the second item that is below a stored threshold for that item. In this case, the request, or at least a part of the request associated with that item, is eliminated from further processing. Requests are organized into groups having the same or similar items. Similarities may be determined based on features associated with items.

In some instances, flexibility rules may be applied to groups of requests. These rules are derived from stored information associated with users. Information representing each of the groups of requests and, where appropriate modified by the flexibility rules, is then made available to a plurality of suppliers, and at least one supplier provides a bid to fulfill each request in one of the groups. Furthermore, alternatives to specific requests may also be provided to the suppliers for bid under certain circumstances.

In conjunction with the bidding process described above, the system and methods in accordance with the present invention also continually shop the distribution system for changes in price and reservation cancellations. If the system determines that an acceptable price is offered by the distribution system, due to a sale or consumer cancellation, the system books the request at the offered price.

System Operation

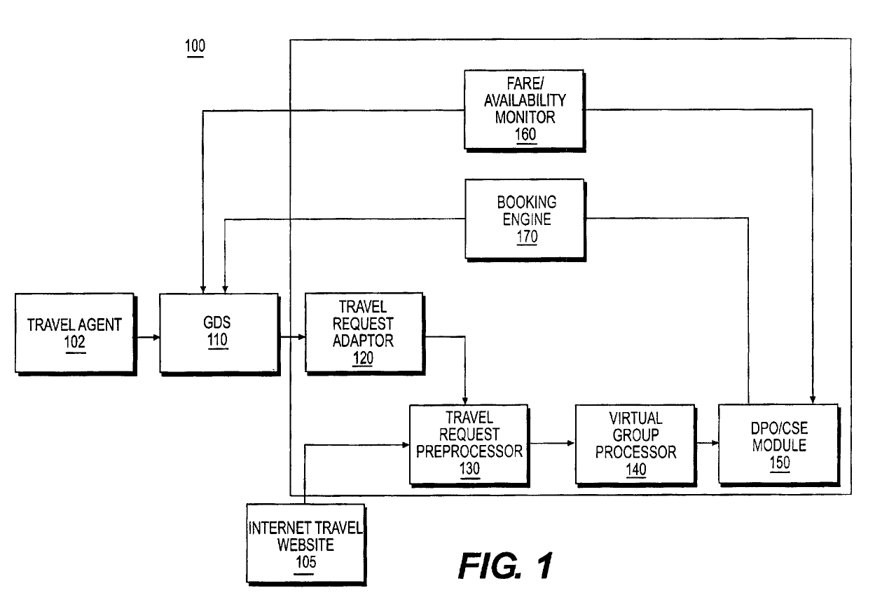

FIG. 1 illustrates a block diagram of system 100, which is consistent with the present invention and reduces the price a consumer pays for travel-related products or services, such as an airline ticket, a hotel room, or a rental car. In one embodiment, system 100 comprises a travel request adapter 120, a travel request preprocessor 130, a virtual group manager 140, a dynamic packaging orchestrator and continuous shopping engine module (DPO/CSE module) 150, a booking engine 170, a fare and availability monitor 160, and time triggers 162.

Travel request preprocessor 130 receives data from a global distribution system (GDS) 110 via a travel request adapter 120 or from other sources such as the Internet via a travel website 105. Thus, a consumer can use system 100 either by booking a travel request through a travel agent 102 or by making a travel request via website 105. When a consumer books a travel request through travel agent 102, travel agent 102 transmits the travel request to system 100 where the travel request is stored in a queue in GDS 110 and then forwarded to travel request adapter 120. The travel request transmitted to GDS 110 from travel agent 102 is normally in the form of a Passenger Name Record (PNR).

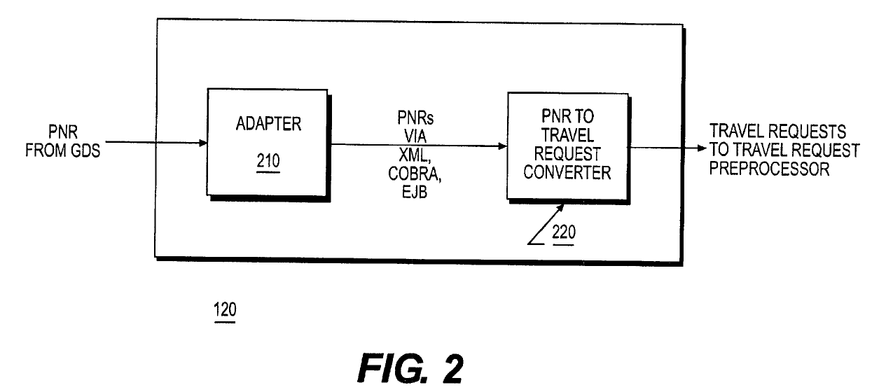

As illustrated in FIG. 2, travel request adapter 120 converts the PNR into a data format for further processing by system 100. Within travel request adapter 120, the PNR is submitted to adapter 210, which converts the PNR to a standard protocol, such as EXtensible Markup Language (XML), Common Object Request Broker Architecture (CORBA), or Enterprise JavaBeans (EJB). Once the PNR is converted to the standard protocol, it is submitted to PNR travel request converter 220, which converts the PNR in the standard protocol to a travel request.

When the PNR is transmitted from the GDS 110 to system 100 in a standard protocol or the travel request is submitted from an Internet travel website in a standard protocol, such as XML, CORBA, or EJB, the PNR or travel request may be submitted directly to PNR travel request converter 220 to obtain a request that can be processed by system 100.

The resulting request comprises some or all of the data contained in the PNR and additional information added by travel request adapter 120. The additional information includes flexibility information or rules. For example, if a consumer books a flight travel request through travel agent 102, the travel request will include the departure location and time, the arrival location and time, and the flight carrier. Travel request adapter 120 will convert the travel request by adding information indicating that the consumer is flexible on the time the consumer departs or arrives at the destination. As another example, travel request adapter 120 may add information based on its own pre-set rules or profile information on the consumer.

Travel request preprocessor 130 receives the request from travel request adapter 120 and filters it by accepting or rejecting the request based on elimination rules. For example, if a request contains a request to fly from location A to location B for less than ten dollars, then travel request preprocessor 130 may reject the request because of the suggested low price. The travel request preprocessor 130 may also reject the request if the travel product or service is unavailable (e.g., no airport at the destination city or the consumer has requested a carrier that offers no service to the destination city).

An accepted request is transmitted to virtual group processor 140 where it is compared with other requests and grouped with other requests for similar travel-related products or services. For example, a request with the same departure and same arrival information as another request may be grouped together. As another example, the time of departure and time of arrival may be compared, and the requests with similar times may be grouped.

The grouped requests are transmitted to DPO/CSF module 150. However, if a request cannot be grouped with the same or similar request, it is transmitted individually to DPO/CSE module 150.

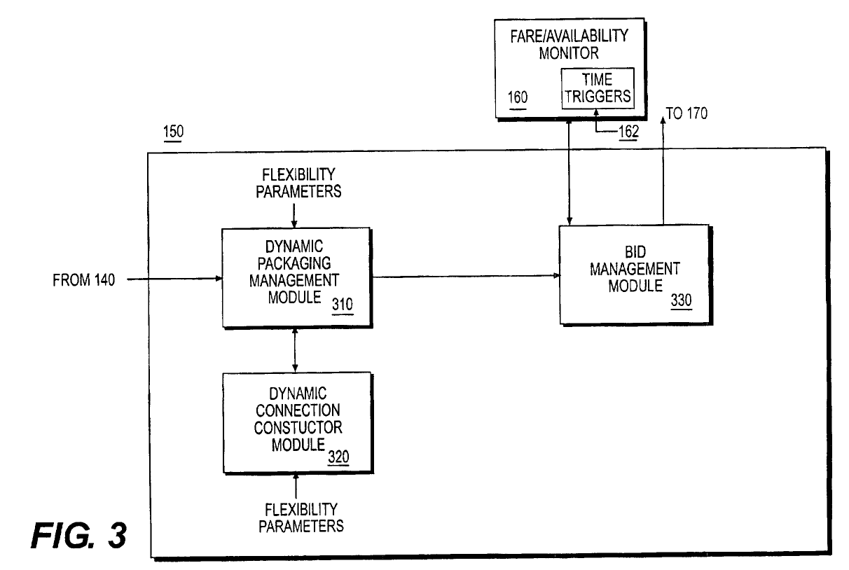

DPO/CSE module 150 performs dynamic packaging management, dynamic flight connection construction, bid management, and continuous shopping. These functions will be explained below with reference to FIG. 3.

As illustrated in FIG. 3, the dynamic packaging management module 310 receives a grouped or an individual request from virtual group processor 140 and splits the request into multiple products, if possible. For example, if dynamic packaging management module 310 receives a request consisting of a flight, car, and hotel request, then the dynamic packaging management module 310 splits the request into three separate requests, a flight request, a car request, and a hotel request. Dynamic packaging management module 310 may also use flexibility rules to create additional requests that are provided to the suppliers for bidding along with the separate requests. The flexibility rules may be derived from customer profiles, which may include alternate airlines, departure times, arrival times, vehicle types, and/or hotel chains that the consumer is willing to use.

Dynamic flight connection constructor module 320 receives the flight request from the dynamic packaging management module 310. Based on the departure and arrival information in the flight request and flexibility parameters, dynamic flight connection constructor module 320 generates a list of alternative flight requests. The alternative flight requests may include multiple connections between the departure and arrival locations in the original flight request. For example, if an original flight request contains a request to fly from location A to location B, based on this information and additional flexibility parameters, the dynamic flight connection constructor module 320 generates a list of alternative flight requests, which may include a request to fly from location A to location B with connections at locations C and D. The list of alternative flight requests are transmitted back to dynamic packaging management module 310, which then transmits the original and alternative flight requests to the bid management module 330.

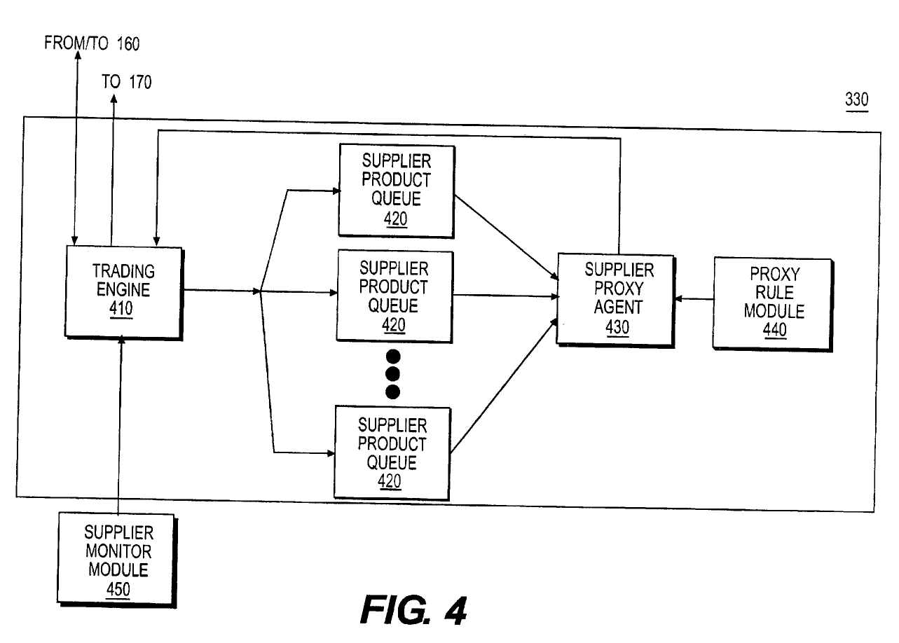

As shown in FIG. 4, the bid management module 330 consists of a trading engine 410, supplier product queues 420, supplier proxy agents 430, and a proxy rules module 440. When the bid management module 330 receives the separate requests from dynamic packaging management module 310, trading engine 410 transmits requests for quotes to the supplier product queues 420. There is a supplier product queue for storing each type of request (e.g., flight, hotel, or car request) that is offered to the suppliers for bidding. Other queues may also be provided, such as origin, destination, and date queues.

The supplier product queues 420 transmit the requests for quotes to supplier proxy agents 430, which automatically bid on the requests using proxy rules supplied by proxy rules module 440. For example, a supplier proxy agent 430 may be set to automatically bid on a flight request if the request is for a flight from location A to location B on a particular day and time. The supplier proxy agents are software modules that manage the supplier queues from the supplier side of the system. Suppliers may also manually monitor supplier product queues 420 for bidding on products manually through supplier monitoring module 450. The automatic bids and the manual bids are transmitted to the trading engine 410.

In addition to receiving automatic bids and manual bids, the trading engine 410 receives information from the fare and availability monitor 160, which continually transmits information such as fare changes and reservation cancellations occurring in the GDS 110. Using the fare and availability monitor 160 and time triggers 162, the DPO/CSE module continuously shops for travel products or services (e.g., flight, hotel, or car offerings) to satisfy a request. Additionally, the continuous shopping feature causes a re-shop if an interval of time passes (i.e., time triggers 162 expire) without a fare or availability event triggering a reevaluation of the request. The travel product or service located through the fare and availability monitor 160 and time triggers 162 may be the same as or similar to the travel product originally requested in the original request, based on the flexibility rules explained above.

Recall that a grouped or individual request is split into separate requests by dynamic packaging management module 310 and each separate request is transmitted to trading engine 410 for bidding. When trading engine 410 receives the automatic bids from supplier proxy agents 430, the manual bids from the suppliers, and information from the fare and availability monitor 160 and time triggers 162, trading engine 410 awards the bids for each separate request. Trading engine 410 then repackages the separate requests to produce a single request for each consumer (assuming that original request was grouped with other requests for similar products or services and was not processed individually) and transmits the request to booking engine 170 for booking in GDS 110. Booking engine 170 converts the request into a data format used by GDS 110.

The foregoing description of an implementation of the invention has been presented for purposes of illustration and description. It is not exhaustive and does not limit the invention to the precise form disclosed. Modifications and variations are possible in light of the above teachings or may be acquired from practicing the invention.

For example, the described implementation includes software but the present invention may be implemented as a combination of hardware and software or in hardware alone. The invention may be implemented with both object-oriented and non-object-oriented programming systems. Additionally, components of the present invention are stored in memory; one skilled in the art will appreciate that these components can be stored on other types of computer-readable media, such as secondary storage devices like hard disks, floppy disks, or CD-ROM; a carrier wave from the Internet or other propagation medium; or other forms of RAM or ROM. The scope of the invention is defined by the claims and their equivalents.

Conclusion

The systems and methods according to the present invention enable consumers to take advantage of the buying power available to groups seeking products and services, and the ability to make a single request and have that single request continually shopped by the system until a response that matches the request is found, subsequently booked, and reported to the travel agent or consumer.

The systems and methods according to the present invention also provide alternative services or products to the consumer's request, group the alternative products or services with the request of other consumers, and offer the grouped requests for the products or services to suppliers for bid; thereby satisfying the consumer's request, while providing the lowest possible price for the product or service.

What is claimed is:

1. A system for auctioning consumer demand to suppliers comprising:
a request adapter for receiving a first data set in a first protocol, converting the first data set to a second data set in a second intermediate protocol and then, converting the second data set to a third data set in a third protocol;
a request preprocessor for receiving the third data set from the request adapter and filtering the third data set;
a virtual group processor for receiving the third data set, which has been filtered by the request preprocessor and un-rejected, and creating at least one group, including the third data set and other data sets in the third protocol; and
a dynamic packaging orchestrator and continuous shopping engine (DPO/CSE) for managing the at least one group, shopping for bids on at least one product represented in the at least one group, and booking the at least one product based on the received bids.

2. The system of claim 1, wherein the first data set is a PNR and the third data set is a travel request.

3. The system of claim 1, wherein the first data set is a PNR, the second data set in the second intermediate protocol is a standard protocol, and the third data set in the third protocol is a travel request.

4. The system of claim 1, wherein the request preprocessor filters the third data set based on a set of elimination rules that eliminate or accept the travel request, based on a consumer's flexibility and the travel request availability.

5. The system of claim 4, wherein if the third data set does not meet the elimination rules it is rejected.

6. The system of claim 1, wherein the virtual group processor creates the at least one group or processes the third data set individually.

7. The system of claim 1, wherein the DPO/CSE manages the at least one group by applying flexibility rules.

8. The system of claim 7, wherein if the at least one group represents a plurality of products, the DPO/CSE manages the at least one group by disassembling the plurality of products and re-assembling the plurality of products into one or more combinations of products before shopping for bids.

9. The system of claim 8, wherein the DPOICSE shops for bids on the one or more combinations of products by submitting bid requests to suppliers and receiving one or more bids for the one or more combination of products.

10. The system of claim 9, wherein the suppliers submit the one or more bids to the DPO/CSE manually or automatically through proxy agents, based on proxy trading rules.

11. The system of claim 10, wherein the DPO/CSE books the one or more combination of products based on event and availability information.

12. A travel information system for auctioning consumer demand to suppliers comprising:
a request adapter for receiving a PNR from a distribution system and converting the PNR to a travel request;
a request preprocessor for receiving the travel request from the request adapter and filtering the travel request, based on a set of elimination rules;
a virtual group processor for receiving travel requests, filtered by the request preprocessor and un-rejected, and creating at least one group, including the travel requests and other travel requests; and
a dynamic packaging orchestrator and continuous shopping engine (DPO/CSE) for managing the at least one group, shopping for bids on at least one product represented in the at least one group, and using events and availability information to obtain the at least one product represented, and booking the at least one product.

13. The system of claim 12, wherein the request adapter uses an intermediate standard protocol to convert the PNR to the travel request.

14. The system of claim 12, wherein the DPO/CSF manages the at least one group by applying flexibility rules.

15. The system of claim 12, wherein the virtual group processor creates the at least one group or processes the travel request individually.

16. The system of claim 12, wherein if the at least one group represents a plurality of products, the DPO/CSE manages the at least one group by organizing the plurality of products into one or more combinations of products before shopping for bids.

17. The system of claim 16, wherein the DPO/CSE shops for bids on the one or more combinations of products by submitting bid requests to suppliers and receiving one or more bids for the one or more combination of products.

18. The system of claim 17, wherein the suppliers submit the one or more bids to the DPO/CSE manually or automatically through proxy agents, based on proxy trading rules.

19. A method for auctioning consumer demand to suppliers in a travel information network comprising the steps of:
transferring a PNR from a distribution system to a request adapter for conversion to a travel request;
transferring the travel request from the request adapter to a request preprocessor;
filtering the travel requests with the request preprocessor;
transferring the filtered travel requests that are un-rejected to a virtual group processor;
forming at least one group, including the travel requests and other travel requests with the virtual group processor; and
transferring the at least one group from the virtual group processor to a dynamic packaging orchestrator and continuous shopping engine (DPO/CSE) that:
manages the at least one group,
shops for bids on at least one product represented in the at least one group,
receives bids on the at least one product represented in the at least one group, and
books the at least one product based on the received bids.

20. The method of claim 19, further comprising converting the PNR to an intermediate protocol and then to the travel request.

21. The method of claim 19, wherein the filtering step includes filtering the travel request based on a set of elimination rules.

22. The method of claim 19, wherein the forming step further includes forming the at least one group or processing the travel request individually.

23. The method of claim 22, wherein managing the at least one group further includes applying consumer and supplier profile rules to the travel request.

24. The method of claim 23, wherein managing the at least one group includes disassembling a plurality of products and re-assembling the plurality of products into one or more combinations of products before shopping for bids.

25. The method of claim 24, wherein receiving the one or more bids at the DPO/CSE further includes receiving bids from suppliers that have submitted the bids manually or automatically through proxy agents, based on proxy trading rules.

26. The method of claim 25, wherein the step of booking the travel request includes acquiring the one or more combination of products based on event and availability information received by the DPO/CSE.

27. A method for booking a travel request comprising:
receiving the travel request;
continuously shopping the travel request at a distribution system;
reevaluating a price offered at the distribution system to fulfill the travel request; and
booking the travel request at the distribution system if it is determined that an appropriate price is offered at the distribution system.

28. The method of claim 27, wherein the step of continuously shopping the travel request at the distribution system includes monitoring fare and event availability information.

29. The method of claim 27, wherein the step of continuously shopping the travel request at the distribution system includes using time triggers to initiate the continuous shopping at the distribution system.

30. A dynamic packaging orchestrator and continuous shopping engine (DPO/CSE) comprising:
a dynamic packaging management module for dividing one or more grouped travel requests into a plurality of individual requests represented in the one or more grouped requests and creating additional requests based on flexibility rules;
a dynamic cornection constructor module for receiving the one or more grouped requests and generating a list of alternate requests, based on a consumer's flexibility, and submitting the alternate requests to the dynamic packaging management module; and
a bid management module for:
receiving the plurality of individual requests, the additional requests, and the alternate requests from the dynamic packaging management module,
offering the plurality of individual requests, the additional request, and the alternate requests for bidding,
receiving bids on the plurality of individual requests, the additional requests, and the alternate requests and determining whether one or more of the bids are acceptable, and
booking one or more of the bids that were acceptable with a distribution system.

31. A method for providing item requests comprising:
receiving requests for items from at least one of a plurality of sources;
processing the requests for items received in a standard format or converting the request for items received in other formats to a standard format;
eliminating the request for items that fail to meet a predetermined criteria;
reorganizing the request for items into groups having the same or similar items;
offering the groups for bid to prospective suppliers;
receiving a bid from at least one of the prospective suppliers that fulfill an item within one of the grouped request for items.
